(19) United States
(12) Patent Application Publication
(10) Pub. No.: US 2008/0089485 A1
(43) Pub. Date: Apr. 17, 2008

(54) Systems and Methods for Single End Loop Testing

(75) Inventors: Patrick Duvaut, Tinton Falls, NJ (US); Amitkumar Mahadevan, Eatontown, NJ (US); Feng Ouyang, Dayton, MD (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: CONEXANT SYSTEMS, INC., Red Bank, NJ (US)

(21) Appl. No.: 11/865,817

(22) Filed: Oct. 2, 2007

Related U.S. Application Data
(60) Provisional application No. 60/848,400, filed on Oct. 2, 2006.

(51) Int. Cl. H04M 1/24

(52) U.S. Cl. 379/1.03

(57) ABSTRACT

Systems and methods for performing single-end line testing (SELT) are described. At least one embodiment includes a method for SELT to determine loop characteristics for a loop. The method for performing SELT comprises generating a test signal through a loop to be tested and receiving an echo response. The method further comprises subtracting predetermined near end echo response from the received echo to derive a far end echo response, performing time-dependent scaling on the far end echo response to compensate for loop attenuation, comparing the time-scaled far end echo response to a set of predefined templates, and providing an estimate of loop characteristics by identifying a matching template within the set of predefined templates, wherein the matching template contains information relating to loop characteristics comprising loop length and loop termination.

### CROSS-REFERENCE TO RELATED APPLICATION

This application claims priority to, and the benefit of, U.S. Provisional Patent Application entitled, “SYSTEMS AND METHODS FOR SINGLE END LOOP TESTING,” having Ser. No. 60/848,400, filed on Oct. 2, 2006, which is incorporated by reference in its entirety.

### TECHNICAL FIELD

The present disclosure generally relates to point-to-point wire line communications and more particularly to single end loop testing of digital subscriber line (DSL) communication systems.

### BACKGROUND

Single-ended loop testing (SELT) can be used to extract information about the transmission environment (e.g., the loop) in a DSL system by performing reflective measurements. SELT provides useful information where the transmission environment is affected by various factors such as the transmission medium (e.g., the wireline) itself, the noisy environment in which the transmission medium operates, and the effects introduced by DSL devices onto the transmission medium. Information regarding the transformation environment may include, for example, loop length and loop termination type. As an example, SELT may comprise injecting signals into a loop under test at a central office (CO) in order to determine the loop capability for supporting different kinds of DSL services. As such, SELT often plays an important role in DSL provisioning and maintenance.

Typically, only the CO is involved in loop testing and SELT is used to extract reflected signal information (typically referred to as far end echo) from the measurements. Generally, the actual received signal (typically referred to as near end echo) and the desired signal are strongly correlated as both the received signal and the desired signal are reflections of the same input signal with the exception of signal strength and time difference between the two echoes. The difficulty in performing SELT lies in the fact that even the tail end of near end echo is generally much stronger than the far end echo such that the latter is completely submerged in the correlated background noise.

### SUMMARY

Briefly described, one embodiment, among others, includes a method for SELT that provides accurate determination of loop characteristics for a loop. The method for performing SELT comprises generating a test signal through a loop to be tested and receiving an echo response. The method further comprises subtracting predetermined near end echo response from the received echo to derive a far end echo response, performing time-dependent scaling on the far end echo response to compensate for loop attenuation, comparing the time-scaled far end echo response to a set of predefined templates, and providing an estimate of loop characteristics by identifying a matching template within the set of predefined templates, wherein the matching template contains information relating to loop characteristics comprising loop length and loop termination.

Another embodiment includes an apparatus for performing single-end line testing. The apparatus comprises a transmitter adapted to transmit a test signal through a loop to be tested, a receiver having an input that receives an echo response signal resulting from the transmission of the test signal, and a processing unit configured to subtract a predetermined near end echo response from the received echo response signal in order to derive a far end echo response. The apparatus further comprises a time scaler configured to perform time-dependent scaling on the far end echo response to compensate for loop attenuation and a comparison module configured to compare the time-scaled far end echo response to a set of predefined templates and provide an estimate of loop characteristics by identifying a matching template within the set of predefined templates, wherein the matching template contains information relating to loop characteristics comprising loop length and loop termination.

Yet another embodiment includes a program stored on a computer readable medium for performing single-end line testing to determine loop characteristics for a loop. The program comprises logic for generating a test signal through a loop to be tested, logic for receiving an echo response, logic for subtracting predetermined near end echo response from the received echo to derive a far end echo response, logic for performing time-dependent scaling on the far end echo response to compensate for loop attenuation, logic for comparing the time-scaled far end echo response to a set of predefined templates, and logic for providing an estimate of loop characteristics by identifying a matching template within the set of predefined templates, wherein the matching template contains information relating to loop length and loop termination.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a table of length estimation results and mean squared error figures.

FIG. 2 provides a comparison of the smallest deviation associated with Bridged Tap (BT) loops while performing SELT according to various embodiments of the invention.

FIG. 3 is a histogram of the matching errors for a straight loop and a BT loop while incorporating 2^{nd} order polynomial fitting according to various embodiments of the invention.

FIG. 4 is a histogram of the matching errors for a straight loop and a BT loop while incorporating 6^{th} order polynomial fitting according to various embodiments of the invention.

FIG. 5 is a histogram of matching errors across different background noise profiles.

FIG. 6 is a plot of background echo deviation from the average value.

FIG. 7 illustrates Home Wiring Model 1 as defined in ITU-T G.996.1.

FIG. 8 illustrates Home Wiring Model 2 as defined in ITU-T G.996.1.

FIG. 9 depicts an embodiment of a method for performing single-end loop testing (SELT).

FIG. 10 depicts an exemplary embodiment of an apparatus for performing the SELT method depicted in FIG. 10.

FIG. 11 is a schematic diagram of an embodiment of a DSL modem incorporating SELT.

In order to facilitate a fuller understanding of the present disclosure, reference is now made to the accompanying drawings, in which like elements are referenced with like numerals. These drawings should not be construed as limiting the present disclosure, but are intended to be exemplary only.

### DETAILED DESCRIPTION

Having summarized various aspects of the present disclosure, reference will now be made in detail to the description of the disclosure as illustrated in the drawings. While the disclosure will be described in connection with these drawings, there is no intent to limit it to the embodiment or embodiments disclosed herein. On the contrary, the intent is to cover all alternatives, modifications and equivalents included within the spirit and scope of the disclosure as defined by the appended claims.

Far end echo contains information regarding the loop termination at the far end as well as the overall loop length. As briefly described earlier, far end echo is generally much weaker than near end echo due to loop attenuation. It is therefore necessary to isolate contribution from the far end signal in order to conduct accurate SELT measurements. In view of the forgoing, various embodiments of the invention provide a cost-effective method for accurately performing single-end loop testing. In particular, exemplary embodiments determine loop lengths with up to 10% accuracy for 26 AWG wires.

For various embodiments, if the loop length cannot be determined correctly due to topology issues (such as those due to bridged taps), an “invalid” flag is returned instead of an erroneous length estimate. Furthermore, exemplary embodiments described herein are optimally used for loop lengths ranging from 0 to 9 kft. For loop lengths greater than 9 kft, an indication is given that the loop length exceeds 9 kft rather than providing a potentially erroneous length estimate.

Embodiments of SELT described herein are based on template matching. For exemplary embodiments, four templates are provided for each xDSL modem, and the measured echo response of the analog front end (AFE) for each xDSL modem is then matched to one of the templates. If a match is found, the loop length may be determined by simply identifying the corresponding template. Conversely, if a match is not found, a determination is made that the current loop is not in a straight loop configuration, and the measurement is flagged as being invalid.

In practical applications, it is desirable to incorporate SELT into a DSL modem as DSL modems include both transmit and receiver circuitry in addition to digital signal processors. In order to utilize a DSL modem to perform SELT, the response of the analog front end (AFE) of the modem must be first characterized and then removed (or taken into account) in order to determine the true response of the loop. Generally, there are three methods for performing SELT using a DSL modem or customer premise (CP) equipment. One approach, which will be referred to as “per-design calibration,” involves characterizing the AFE during the design phase. In particular, a particular AFE design is characterized and then associated with all DSL modems that incorporate that particular AFE design.

These characteristics are then later accounted for when performing SELT analysis. For example, the characteristics may be incorporated into SELT analysis software. This allows the software to be calibrated with respect to the AFE response. One perceived shortcoming with this approach, however, is that the conditions under which the AFE design is characterized can vary substantially from conditions in which the DSL modem (incorporating the particular AFE design) actually operates. For example, temperature, in addition to the effects of aging over time can become large factors. These and other factors can ultimately affect the precision of data obtained from SELT.

Another approach, which will be referred to as “per-port calibration,” involves characterizing each port at the factory on a port-by-port basis. The data derived at the factory for each port is shipped to end users for them to calibrate their equipment. One perceived shortcoming with this approach is that equipment vendors incur increased equipment cost and operation costs for incorporating such characterization data. Furthermore, end users incur the cost of associating the characterization data with the physical units (i.e., DSL modems). One advantage with this approach is that the accuracy of data derived from SELT is improved because variations between individual units are accounted for. However, the accuracy of the data can still be affected by changes in operating conditions.

Another approach (referred to here as “per-run calibration”) involves characterizing the AFE either before or after every SELT measurement. One perceived shortcoming with this approach is that additional hardware is required in the modem in order to perform such operations. Furthermore, the SELT measurement time is increased, thereby adding cost to the end user. One advantage, however, is that the level of precision is generally the highest for this method when compared to the other approaches described.

Various embodiments of this invention are based on an improved per-design calibration method. In general, the ultimate goal for SELT is to determine, based on measured responses, parameters relating to the particular loop configuration such as: the wire type, the particular connection topology, the length for each loop section, etc. This is typically very difficult to accomplish, particularly with the uncertainties introduced during calibration. A more achievable goal is to determine the loop length only for straight loop configurations. One shortcoming with this approach, however, is that the analysis will yield inaccurate results if SELT is performed based on the underlying assumption that the loop is straight when in reality, the loop is arranged in a more complicated configuration (e.g., a loop with bridge taps).

Accordingly, embodiments described herein seek to address the various perceived shortcomings discussed above and seek to determine loop length characteristics for 26 AWG wires at up to 10% accuracy. For exemplary embodiments of the invention, if the loop length cannot be accurately determined due to the particular topology (e.g., a loop with bridge taps), an “invalid” flag is returned rather than an erroneous length estimate. Furthermore, various embodiments of the invention perform optimally on systems with a loop length of 9 kft or less. If the loop is longer than 9 kft, various embodiments of the present invention provide an indication that the loop is longer than 9 kft (e.g., via an indicator stating “loop>9 kft”) instead providing an inaccurate length estimate.

Exemplary embodiments provide accurate SELT data by incorporating template matching where the measured echo response (wherein the AFE response, or near-end echo, is removed on a per-design basis) is matched (with respect to mean squared error) with pre-defined templates. If a “good” match is obtained, the loop length is determined based on the identity of the matching template. A “good” match occurs when the mean squared error (MSE) for a particular measurement is less than or equal to a pre-determined threshold value. If no matches are found, an indication is given that the loop is in a configuration other than a straight loop configuration. For some embodiments, the indication may simply comprise an “invalid” flag.

In various embodiments, the SELT operation according to various embodiments of the invention may be implemented on hardware such as the CONEXANT G8/G24 CO platform available from Conexant Systems, Inc. of Red Bank, N.J. During the measurement phase, a pseudo-random sequence is transmitted, and at the same time, the receiver records the signal as reflected from the front end and the loop. The received signal is then correlated with the transmitted signal. Since the auto-correlation of the transmitted sequence is approximately a delta function, the result is the echo response of the channel.

Exemplary embodiments for loop testing begin by subtracting the background noise (i.e., near end echo) from the raw echo response. The background data is obtained by measuring the echo response for 18 kft loops, which for purposes herein can be considered as infinitely long. (Far-end echo can be considered as negligible for this loop length.) The echo response for 18 kft loops is measured for a large number of DSL modems such that a large number of samples are obtained. An average of all the measurements is then calculated. This average value for the near end echo serves as characterization data for the particular AFE design incorporated into the DSL modems. The mean of the measurements is later subtracted from measurements taken in the field in order to derive the far end echo.

Next, time-based equalization is performed wherein a scaling operation is performed. In particular, the data is multiplied by the function, 10^{t/0.009}, where t represents the sampling time in milliseconds. This scaling operation is performed to roughly compensate for the loop attenuation experienced as a result of echo signals traveling down different loop lengths (and as a result, appearing at different time instances).

The templates used for template matching are derived from measurements. Echo signals from loops with varying known lengths are collected and processed as described before in order to form the templates for the corresponding loop lengths. The error is the difference between the measured echo and the template. This difference is then fitted using a 6^{th} order polynomial, which is subsequently subtracted from the difference. This removes the slow-varying component in the difference, which is due to variations of the background (near-end echo). After performing these operations, the norm of the difference (from points 1 to 73) represents the matching criterion.

For each measurement, matching criteria is then computed for templates representing various loop lengths and terminations. The best match is then used to determine the loop length and termination estimate. If the best matching criterion has a value exceeding a certain threshold, a determination is made that the loop is not a straight loop, and the length cannot be estimated.

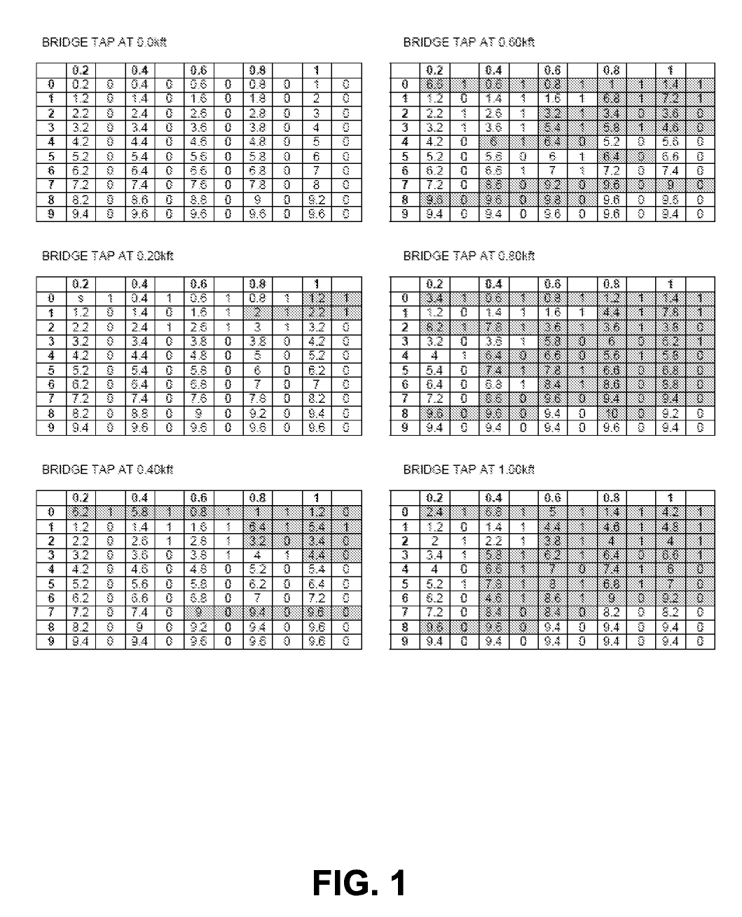

Various simulations are now discussed in order to illustrate the improved performance of SELT when applying the exemplary techniques described above. FIGS. 1-6 illustrates the results from these simulations performed using exemplary embodiments for performing SELT described herein. For the simulations described below, background noise data was first derived for one particular hardware unit. In order to simulate variations in the near-end echo caused by different hardware units, background data was collected from 56 different DSL ports. While this is in contrast to real operating scenarios where a common background noise data set is used and where the actual near end echo changes during operation, the variations in near end echo is equivalent to those experienced under actual operating conditions for purposes of these simulations.

Reference is made to FIG. 1, which provides a table of SELT results for bridge taps (BT) at varying loop lengths. The tables in FIG. 1 provide length estimation results and mean squared error figures. The length estimation values in the tables are measured in kilofeet. Each length estimation value is accompanied by the associated mean squared error (to the right). The shaded portions of the tables reflect undetected errors. As seen from the table in FIG. 1, the maximum deviation for straight loops is 10^{0.2}. The minimum deviation for loops with bridge taps, with wrong estimation figures, is 10^{-0.2}. It should be noted from FIG. 1 that although straight loops can be estimated correctly, wrong estimates might not be detected.

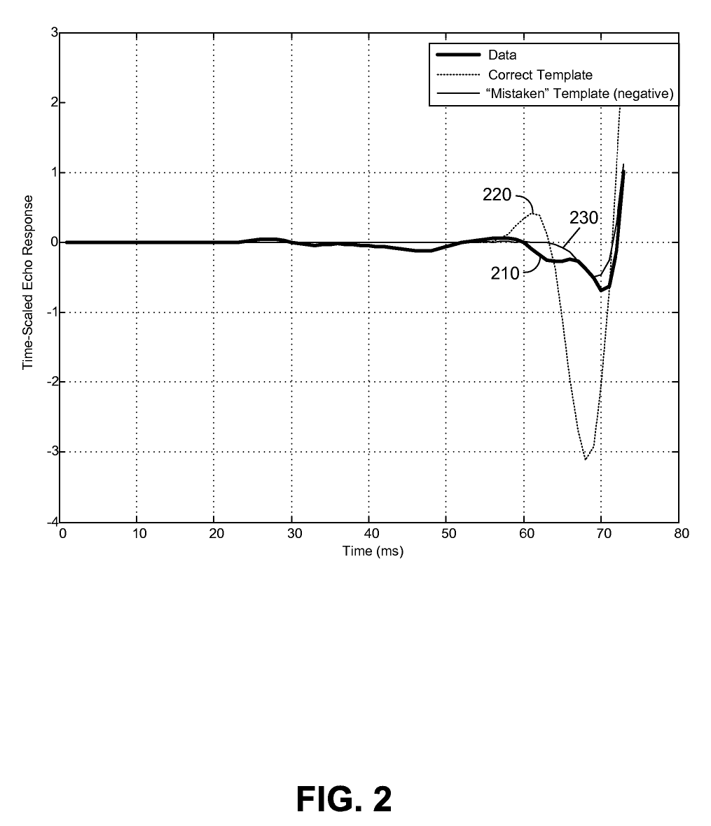

Reference is now made to FIG. 2, which provides a plot of the time-scaled echo response over time in milliseconds. The plot provides a comparison between the actual echo response 210 in addition to a correct template 220 and a “mistaken” template 230. A “mistaken template is a template that is mistakenly matched. In particular, the plot reflects data for the smallest deviation for loops with bridge taps. For the simulation data in FIG. 2, the location of the bridge tap is 0.6 kft. Specifically, the location of the bridge tap is 7 kft from the CO and 0.6 kft from the customer premise. After performing SELT according to the exemplary techniques described earlier, the estimated loop length was determined to be 9.2 kft. It should be noted that the match between the actual data and the mistaken template is actually very good, with the exception of differing signs. The sign is used to account for open-end and closed-end terminations.

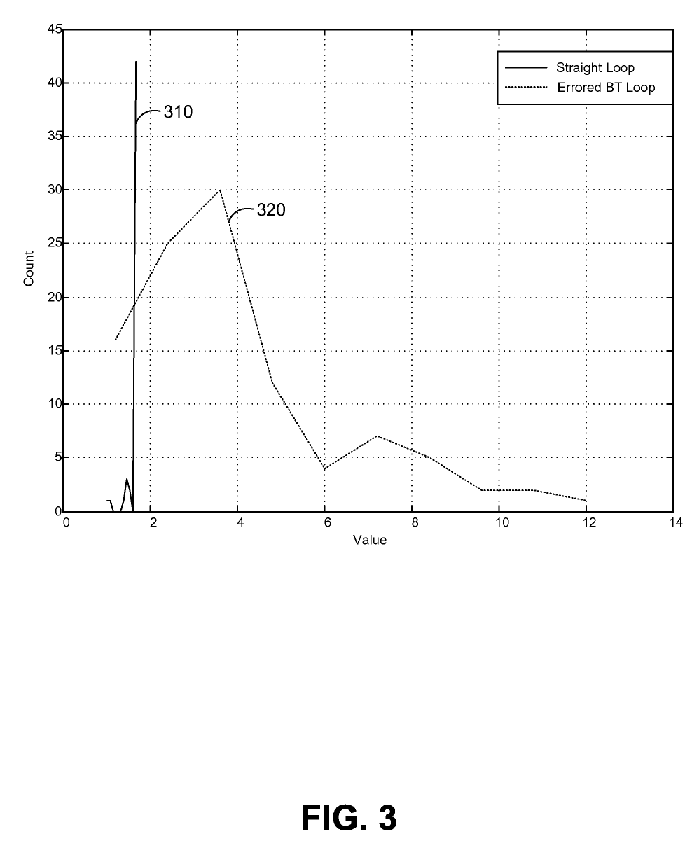

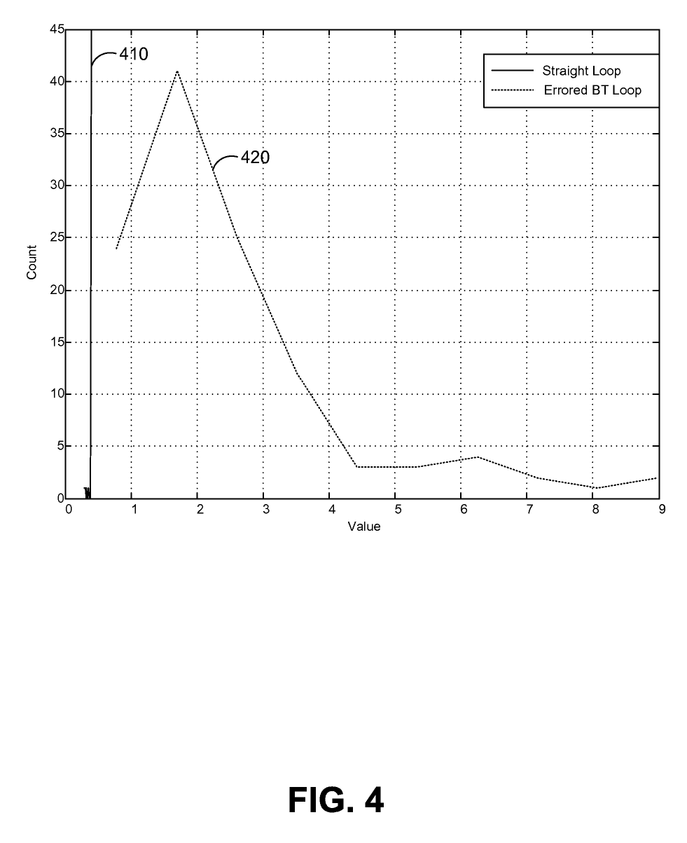

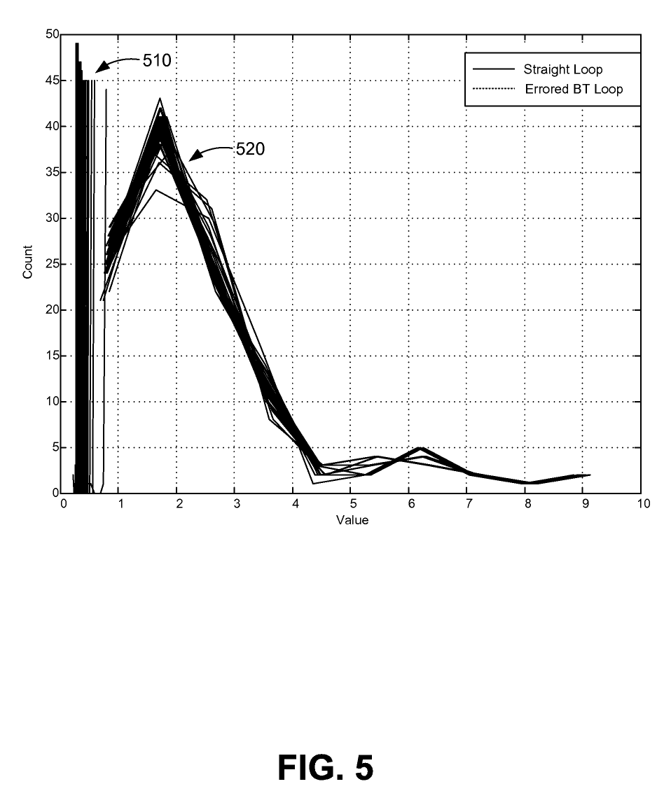

Reference is now made to FIG. 3, which depicts a histogram of the matching errors for both a straight loop 310 and a BT (bridge tap) loop 320 incorporating a 2^{nd} order polynomial fitting. FIG. 4 depicts a histogram of the matching errors for both a straight loop 410 and a BT loop 420 with 6^{th} order polynomial fitting, instead of with a 2^{nd} order polynomial fitting as shown in FIG. 3. When comparing FIGS. 3 and 4, it should be noted that the matching error for straight loops is significantly reduced when utilizing a 6^{th} order polynomial fitting. Furthermore, as seen in FIG. 4, there is no overlap between straight loop data 410 and bridge tap loop data 420 (involving erroneous estimates), as seen in FIG. 3. Finally, FIG. 5 is a histogram of matching errors across different background noise profiles.

Further simulations were performed where exemplary techniques of SELT described herein were performed. For purposes of nomenclature used herein, the following designations are used to classify the simulation results. Class A represents all cases (i.e., the total number of correct estimates and incorrect estimates) where all types of loop configurations were present (e.g., bridge taps near the customer premise, straight loops, etc.) and with varying background noise assumptions. The total number is the denominator when computing the percentage of errors or accuracy level. An estimate is considered to be “correct” when 1) a straight loop configuration is present and the estimation error is less than 10%; or 2) a bridge tap configuration is present and either the estimation error is greater than 10% or the estimation is flagged as being invalid. Classes B, C, and D, described below, comprise erroneous loop length estimations.

Class B refers to instances where straight loop estimates were identified as being invalid. Specifically, these are cases where the topology was properly determined to be a straight loop configuration but where the loop length estimation was flagged as being invalid while performing exemplary embodiments of SELT described earlier. Class C denotes straight loop scenarios where the loop length estimates were inaccurate. In particular, these were instances in which the derived estimation was determined to be valid by the estimation algorithm, but where the estimated loop length was 10% or greater from the actual length. Finally, Class D denotes bridge tap loops with wrong estimates. These are instances where the estimates were determined to be valid by the estimation algorithm, but where the estimated loop length was 10% or less from the actual length. As noted earlier, estimates for bridge tap configurations should either yield an estimated loop length greater than 10% from the actual length or should yield an estimated loop length that is simply flagged as being invalid.

Turning now to the simulation results, reference is made to Table 1.1 below.

TABLE 1.1

| Class | Color Code | Class | Counts | Percentage |
|---|---|---|---|---|
| A | — | Total Number of Classes | 16,800 | 100% |
| B | Blue | Straight Loops Identified as | 451 | 2.7% |
| | | Invalid | | |
| C | Red | Straight Loops with Wrong | 0 | 0.0% |
| | | Estimates | | |
| D | Red | BT loops with Wrong | 121 | 0.7% |
| | | Estimates | | |

For the results shown in Table 1.1, the matching threshold was set to 0.45 and 56 different background noise profiles were used for the simulations. Referring to Table 1.1, the following observations were made from the simulation results. First, for Class D errors, a majority of the estimates returned a loop length estimate of 10 kft, which correlated with the template associated with the longest loop length. A small number of estimates returned values of 9.6 kft and 9.8 kft. An even smaller number of measurements returned loop length estimates of 8.8 kft. Based on these observations, further adjustments were possible to address these systematic errors. Furthermore, errors falling under Class B (loop length estimates returned for straight loops flagged as invalid) occurred in clusters. Also, with certain background noise profiles, all loop configurations except those comprising very long straight loops were incorrectly identified during the simulations. As such, certain background noise profiles will result in a higher error rate.

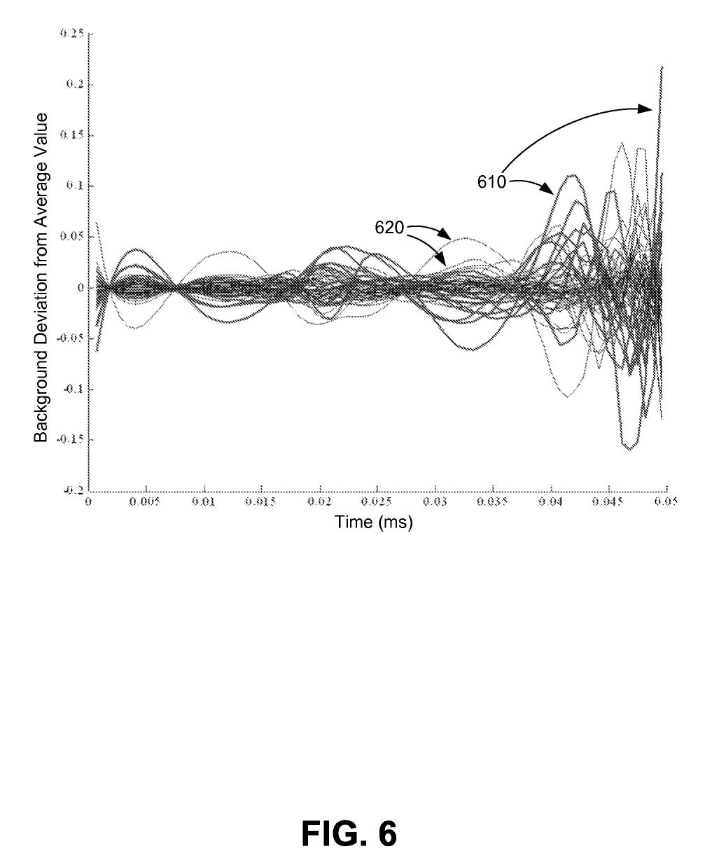

Based on the results shown in Table 1.1., adjustments were made and additional simulations were performed. Reference is now made to FIG. 6, which provides plots of various background data processed according to the exemplary techniques for SELT described earlier. All the background data (i.e., all 56 total cases) was time-scaled according to the scaling technique described earlier. Next, the average value for the background noise (i.e., near end echo) for all 56 cases was calculated. As described earlier, this average value for the near end echo serves as characterization data for the particular AFE design incorporated into the DSL modems used for the simulation. The average of the measurements is later subtracted from measurements taken in the field in order to derive the far end echo response. The plot of the difference is then fitted with a b 6^{th} order polynomial, as discussed earlier. The fitted difference is then subtracted from the difference. The results are shown in FIG. 6.

In FIG. 6, the particular background noise profiles, which result in Class B errors 610 are shown by the bold, heavy lines. The remaining background noise profiles are depicted by thin lines 620. As seen in FIG. 6, the background data that cause Class B errors 610 exhibit a higher degree of deviation from the average compared to the remaining background profiles 620. While one alternative for lowering the number of errors associated with the Class B errors is to adjust the match threshold value in order to reduce false identifications, there is no obvious way for differentiating between “true” and “false” estimates for long loop configurations. As such, embodiments described herein reduce the error rate by flagging estimates associated with loop lengths greater than 9 kft as being too long to flag invalid estimates.

The threshold (for determining matches) can be adjusted to more effectively flag invalid estimates, thereby eliminating errors in straight loops. However, the result is that the error rate for non-straight loops (e.g., bridge tap loops) is higher. To further reduce errors, loop estimates greater than 9 kft are simply rejected. By incorporating these adjustments, the majority of bridge tap loop estimation errors can be eliminated. The results from simulations incorporating these adjustments are shown in Table 1.2 below. Two match threshold values (0.65 and 0.85) were utilized.

TABLE 1.2

| Match | | Color | | | |
|---|---|---|---|---|---|
| Threshold | Class | Code | Description | Count | Percentage |
| 0.65 | A | | (Total Cases) | 16,800 | 100% |
| | B | Blue | Straight Loops | 45 | 0.3% |
| | | | Identified as Invalid | | |
| | C | Red | Straight Loops with | 0 | 0.0% |
| | | | Incorrect Estimates | | |
| | D | Red | BT loops with | 9 | 0.1% |
| | | | Incorrect Estimates | | |
| 0.85 | A | | (Total Cases) | 16,800 | 100% |
| | B | Blue | Straight Loops | 0 | 0% |
| | | | Identified as Invalid | | |
| | C | Red | Straight Loops with | 0 | 0.0% |
| | | | Incorrect Estimates | | |
| | D | Red | BT loops with | 71 | 0.4% |
| | | | Incorrect Estimates | | |

As seen in Table 1.2, as the match threshold is increased (from 0.65 to 0.85), the number of loop estimates flagged as invalid for straight loops decreases to 0 but the number of incorrect estimates for non-straight loop configurations also increases.

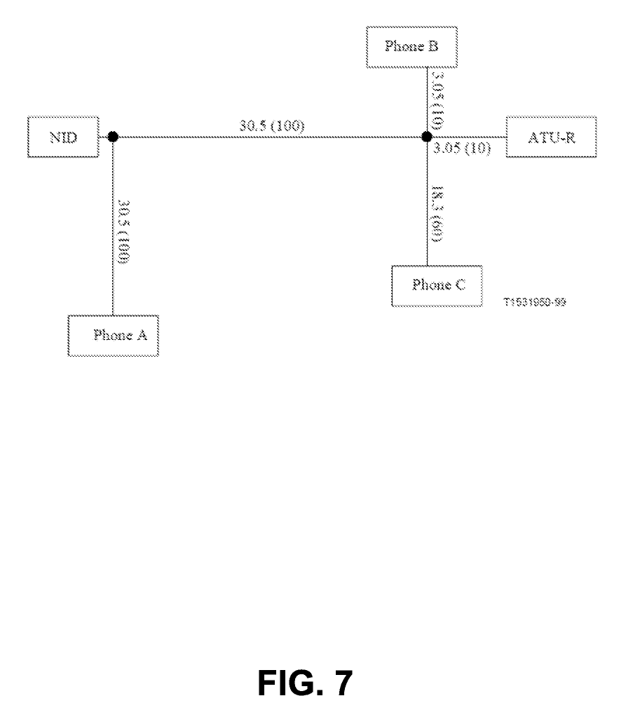

The results shown in the prior sections were based on measurements taken while incorporating Home Wiring Model 1 as defined in International Telecommunication Union standard ITU-T G.996.1 (“Test Procedures for Digital Subscriber Line (DSL) Transceivers”), herein incorporated by reference in its entirety. Generally, test loops and in-home wiring models are specified for different regions of the world for use during DSL performance testing. Reference is made to FIG. 7, which provides Home Wiring Model 1 as defined in ITU-T G.996.1. The lengths are shown in meters while the equivalent lengths in feet are shown in parentheses.

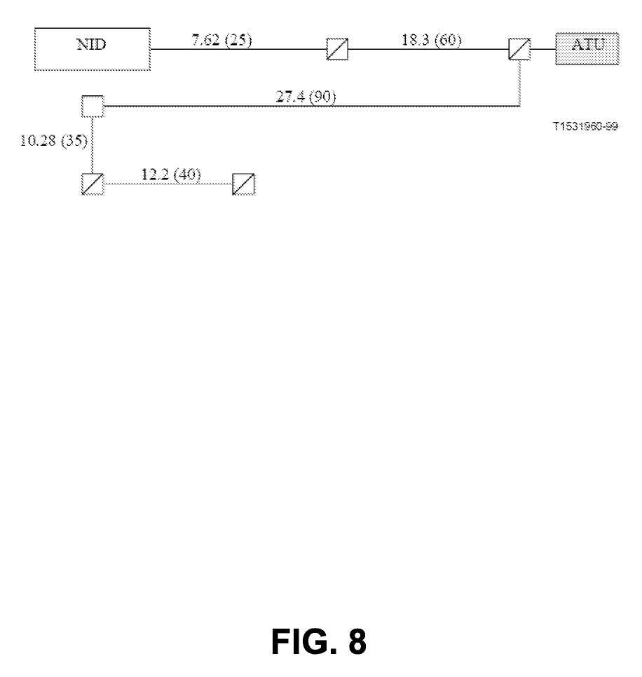

The results which will now be discussed were derived while incorporating Home Wiring Model 2, shown in FIG. 8. Generally, the echo response observed for Home Wiring Model 1 closely tracks the response for a closed loop termination. However, the echo response observed for Home Wiring Model 2 does not closely resemble the response for either a closed or open termination. As such, a different set of templates with a different set of associated thresholds are needed for configurations incorporating Home Wiring Model 2. In this regard, exemplary embodiments employ two sets of templates for the two Home Wiring Models. Furthermore, in addition to estimating the loop length, the termination type (e.g., open vs. closed termination) is determined.

For both sets of estimates (Model 1 and Model 2), the corresponding templates were derived from the same data set (from straight loops), but while using actual background data. The estimation candidates use background data taken from other boards and ports. This reliably simulates variations in background noise experienced between different ports. Table 1.3 below shows the estimation results.

TABLE 1.3

| Match | | Color | | | |
|---|---|---|---|---|---|
| Threshold | Class | Code | Description | Count | Percentage |
| Model 1 | A | — | Total Cases | 16,800 | 100% |
| | B | Blue | Straight Loops | 0 | 0.0% |
| | | | Identified as Invalid | | |
| | C | Red | Straight Loops with | 0 | 0.0% |
| | | | Incorrect Estimates | | |
| | D | Red | BT Loops with | 56 | 0.3% |
| | | | Incorrect Estimates | | |
| | E | Olive | Straight Loops with | 0 | 0.0% |
| | | | Wrong Terminations | | |
| | | | but Correct Length | | |
| | F | Olive | BT Loops with | 114 | 0.7% |
| | | | Wrong Terminations | | |
| | | | but Correct Length | | |
| Model 2 | A | — | Total Cases | 16,800 | 100% |
| | B | Blue | Straight Loops | 0 | 0.0% |
| | | | Identified as Invalid | | |
| | C | Red | Straight Loops with | 0 | 0.0% |
| | | | Incorrect Estimates | | |
| | D | Red | BT Loops with | 382 | 2.3% |
| | | | Incorrect Estimates | | |
| | E | Olive | Straight Loops with | 0 | 0.0% |
| | | | Wrong Terminations | | |
| | | | but Correct Length | | |
| | F | Olive | BT Loops with | 8 | 0.0% |
| | | | Wrong Terminations | | |
| | | | but Correct Length | | |

Next, simulations were performed on loop configurations with CO bridge taps and open/closed terminations. Simulations results reveal that when the home wiring templates derived earlier are used for these scenarios, all loop length estimations for straight loops are either invalidated or yield incorrect estimates. However, when templates that account for these terminations are used, the number of errors decreases and performance is improved. In this regard, exemplary embodiments for performing SELT to derive loop length estimates optimally employ 4 templates to account for Home Wiring Models 1 and 2 and open and closed terminations.

The results when employing 4 templates are shown below in Table 1.4 for central office (CO) and customer premise (CP) bridge taps.

TABLE 1.4

| | | Color | | | |
|---|---|---|---|---|---|
| Termination | Class | Code | Description | Count | Percentage |
| Model 1 | A | — | Total Cases | 16,800 | 100% |
| CP BT | B | Blue | Straight Loops | 3 | 0.0% |
| | | | Identified as Invalid | | |
| | C | Red | Straight Loops with | 0 | 0.0% |
| | | | Incorrect Estimates | | |
| | D | Red | BT Loops with | 54 | 0.3% |
| | | | Incorrect Estimates | | |
| | E | Olive | Straight Loops with | 102 | 0.6% |
| | | | Wrong Terminations | | |
| | | | but Correct Length | | |
| | F | Olive | BT Loops with | 553 | 3.3% |
| | | | Wrong Terminations | | |
| | | | but Correct Length | | |
| Model 2 | A | — | Total Cases | 16,800 | 100% |
| CP BT | B | Blue | Straight Loops | 35 | 0.2% |
| | | | Identified as Invalid | | |
| | C | Red | Straight Loops with | 0 | 0.0% |
| | | | Incorrect Estimates | | |
| | D | Red | BT Loops with | 355 | 2.1% |
| | | | Incorrect Estimates | | |
| | E | Olive | Straight Loops with | 361 | 2.1% |
| | | | Wrong Terminations | | |
| | | | but Correct Length | | |
| | F | Olive | BT Loops with | 832 | 5.0% |
| | | | Wrong Terminations | | |
| | | | but Correct Length | | |
| Open Term. | A | — | Total Cases | 15,120 | 100% |
| CO BT | B | Blue | Straight Loops | 0 | 0.0% |
| | | | Identified as Invalid | | |
| | C | Red | Straight Loops with | 0 | 0.0% |
| | | | Incorrect Estimates | | |
| | D | Red | BT Loops with | 0 | 0.0% |
| | | | Incorrect Estimates | | |
| | E | Olive | Straight Loops with | 2,239 | 14.8% |
| | | | Wrong Terminations | | |
| | | | but Correct Length | | |
| | F | Olive | BT Loops with | 657 | 4.3% |
| | | | Wrong Terminations | | |
| | | | but Correct Length | | |
| Open Term. | A | — | Total Cases | 15,120 | 100% |
| CP BT | B | Blue | Straight Loops | 0 | 0.0% |
| | | | Identified as Invalid | | |
| | C | Red | Straight Loops with | 0 | 0.0% |
| | | | Incorrect Estimates | | |
| | D | Red | BT Loops with | 111 | 0.7% |
| | | | Incorrect Estimates | | |
| | E | Olive | Straight Loops with | 2,239 | 14.8% |
| | | | Wrong Terminations | | |
| | | | but Correct Length | | |
| | F | Olive | BT Loops with | 712 | 4.7% |
| | | | Wrong Terminations | | |
| | | | but Correct Length | | |

Table 1.5 further provides statistics of termination estimates for correct loop length estimates. Each row represents the results for the actual termination present for a particular model or template, as indicated in the left most column.

TABLE 1.5
STATISTICS FOR TERMINATION ESTIMATES

| | (Estimated) | | (Estimated) | | | | | |
|---|---|---|---|---|---|---|---|---|
| | Model 1 | | Model 2 | | (Estimated) | | (Estimated) | |
| | CP BT | | CP BT | | Open CO BT | | Open CP BT | |
| (Actual) | 4,062 | 86.1% | 52 | 1.1% | 283 | 6.0% | 321 | 6.8% |
| Model 1 | | | | | | | | |
| CP BT | | | | | | | | |
| (Actual) | 26 | 0.5% | 3,666 | 75.1% | 1,182 | 24.2% | 6 | 0.1% |
| Model 2 | | | | | | | | |
| CP BT | | | | | | | | |
| (Actual) | 0 | 0.0% | 449 | 15.5% | 2,447 | 84.5% | 0 | 0.0% |
| Open CO | | | | | | | | |
| BT | | | | | | | | |
| (Actual) | 385 | 13.0% | 0 | 0.0% | 0 | 0.0% | 2,566 | 87.0% |
| Open CP | | | | | | | | |
| BT | | | | | | | | |

The estimated terminations are shown in the various columns, as indicated in the top row. The models are numbered in the same sequence as in Table 1.4. Each column shows the number and corresponding percentage of the valid cases that were identified for each termination. For example, row 2, column 4 represents results where the actual configuration was “Model 2 CP BT” but where the estimated termination was determined to be “Open Termination, CP BT”. For this scenario, the number of errors that occurred was 6, or an error rate of 0.1%. It should be noted that the percentages computed in Table 1.5 were based on the total number of valid cases only (i.e., total cases were loop lengths were properly estimated). This is different from the percentages calculated for the other tables above (Tables 1.1-1.4), where the percentage figures were calculated based on the total number of cases (which include both valid and invalid cases).

From Table 1.5, it can be seen that except for Model 1, the cases where the termination was incorrectly estimated tend to be concentrated. Models 2 and 3 are often confused with each other, and Model 4 is often confused with Model 1. This suggests that there are similarities between these groups of the templates. However, the majority of the loops are nevertheless estimated correctly. This means it is still necessary to include all the templates to achieve optimal results.

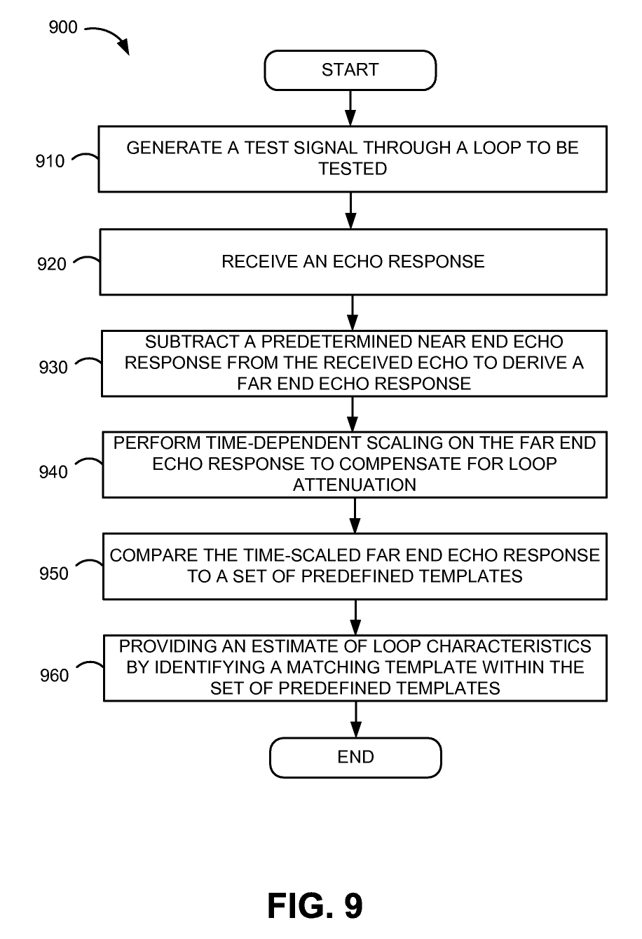

Reference is now made to FIG. 9, which depicts an embodiment of a method for performing single-end loop testing. The exemplary method for performing SELT begins by generating a test signal through a loop to be tested (step 910) and receiving an echo response (step 920). Next in step 930, the near end echo response is subtracted from the received echo to derive a far end echo response. In step 940, time-dependent scaling is performed on the far end echo response to compensate for loop attenuation. The time-scaled far end echo response is then compared to a set of predefined templates in step 950. Finally, in step 960, an estimate of loop characteristics is provided based on information associated with a matching template.

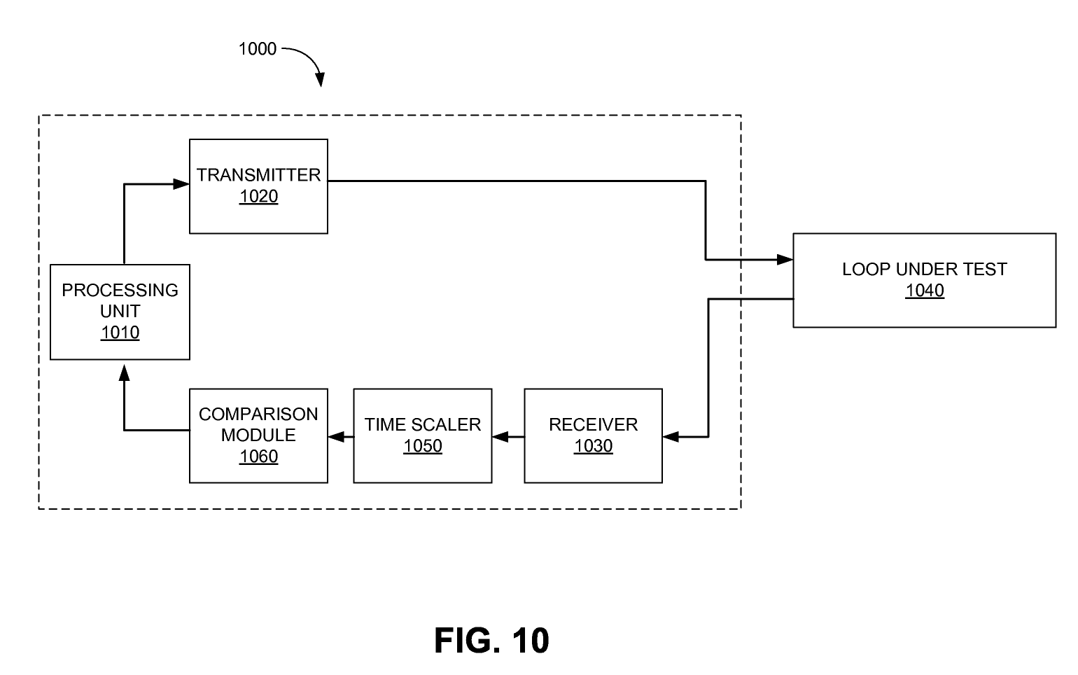

As discussed earlier, it is generally desirable to incorporate SELT into a DSL modem as DSL modems include both transmit and receiver circuitry in addition to digital signal processors. Reference is now made to FIG. 10, which depicts an exemplary embodiment of an apparatus for performing the method depicted in FIG. 9. For exemplary embodiments, SELT may be initiated by a processing unit 1010, such as one incorporated into a DSL modem. The apparatus 1000 may further comprise a transmitter 1020 and a receiver 1030. The transmitter 1020 is configured to transmit a test signal through the loop to be tested 1040. It should be noted that the test signal may be attenuated by existing loop termination devices, such as bridge taps for example.

The receiver 1030 receives an echo response signal resulting from the transmission of the test signal. Upon receiving the echo response signal, the processing unit 1010 subtracts a predetermined near end echo response from the received echo response signal in order to derive the far end echo response for the test signal. The apparatus may further comprise a time scaler 1050 configured to perform time-dependent scaling on the far end echo response to compensate for loop attenuation. The comparison module 1060 shown in FIG. 10 then compares the time-scaled far end echo response to a set of predefined templates and determines loop characteristics by identifying a matching template within the set of predefined templates.

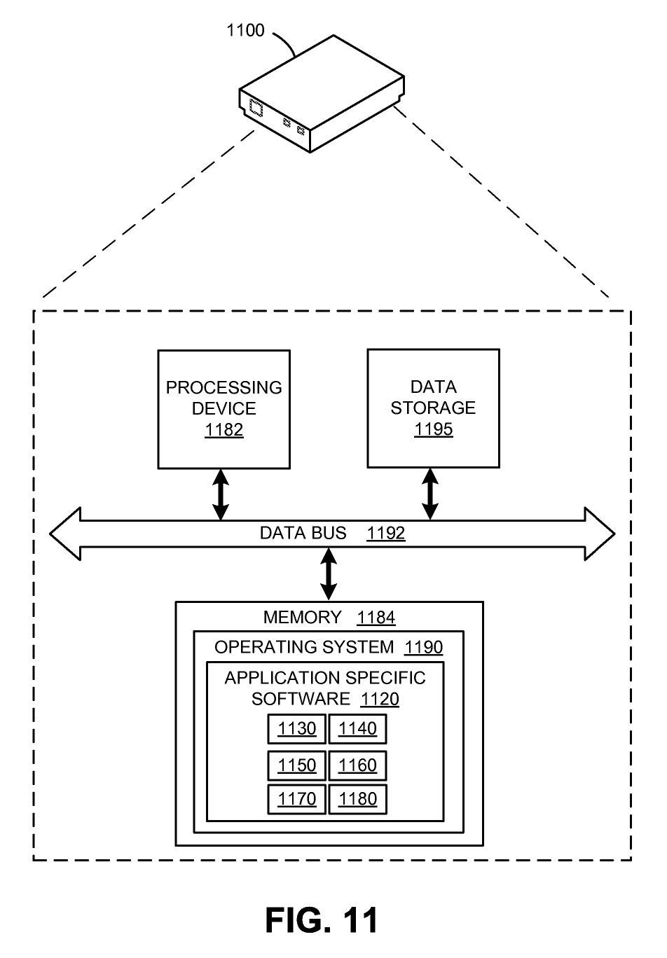

Reference is now made to FIG. 11, which is a schematic diagram of an embodiment of a DSL modem incorporating embodiments of SELT, as described earlier. For some embodiments, the method for performing SELT may be incorporated in software within a DSL modem. One of ordinary skill in the art will appreciate that DSL modems comprise other components, which have been omitted for purposes of brevity. Generally, the DSL modem 1100 may include a processor 1182, a memory component 1184 (which may include volatile and/or nonvolatile memory components), and a data storage component 1195 that are communicatively coupled via a local interface 1192. The local interface 1192 may have additional elements, which are omitted for simplicity, such as controllers, buffers (caches), drivers, repeaters, and receivers to enable communications. Further, the local interface may include address, control, and/or data connections to enable appropriate communications among the aforementioned components. The processor 1182 may be a device for executing software, particularly software stored in the memory component 1184.

The processor 1182 can be any custom made or commercially available processor, a central processing unit (CPU), an auxiliary processor among several processors associated with the DSL modem 1100, a semiconductor based microprocessor (in the form of a microchip or chip set), a macroprocessor, or generally any device for executing software instructions.

The memory component 1184 can include any one or combination of volatile memory elements (e.g., random access memory (RAM, such as DRAM, SRAM, SDRAM, etc.)) and/or nonvolatile memory elements (e.g., ROM, hard drive, tape, CDROM, etc.). Moreover, the memory component 1184 may incorporate electronic, magnetic, optical, and/or other types of storage media. One should note that some embodiments of the memory component 1184 can have a distributed architecture (where various components are situated remotely from one another), but can be accessed by the processor 1182.

The software in memory component 1184 may include one or more separate programs, each of which includes an ordered listing of executable instructions for implementing logical functions. In the example shown in FIG. 11, the software in the memory component 1184 may include an operating system 1190. Furthermore, the software residing in memory 1184 may include application specific software 1120, which may further comprise the following: logic for generating a test signal 1130, logic for receiving echo response 1140, logic for subtracting predetermined near end echo response from the received echo response 1150, logic for performed time-scaling 1160, logic for comparing the time-scaled far end echo response to a set of predefine templates 1170, and logic for determining loop characteristics based on the matching template 1180. The operating system 1190 may be configured to control the execution of other computer programs and provides scheduling, input-output control, file and data management, memory management, and communication control and related services.

A system component and/or module embodied as software may also be construed as a source program, executable program (object code), script, or any other entity comprising a set of instructions to be performed. When constructed as a source program, the program is translated via a compiler, assembler, interpreter, or the like, which may or may not be included within the memory component 1184, so as to operate properly in connection with the operating system 1190.

When the DSL modem 1100 is in operation, the processor 1182 may be configured to execute software stored within the memory component 1184, communicate data to and from the memory component 1184, and generally control operations of the DSL modem 1100 pursuant to the software. Software in memory, in whole or in part, may be read by the processor 1182, perhaps buffered within the processor 1182, and then executed.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

1. A method for single-end line testing (SELT) to determine loop characteristics for a loop, the method comprising:
generating a test signal through the loop to be tested, wherein the test signal is a pseudo-random sequence;
receiving an echo response;
subtracting a predetermined near end echo response from the received echo to derive a far end echo response;
performing time-dependent scaling on the far end echo response to compensate for loop attenuation;
comparing the time-scaled far end echo response to a set of predefined templates; and
providing an estimate of loop characteristics by identifying a matching template within the set of predefined templates, wherein the matching template contains information relating to loop characteristics comprising loop length and loop termination.

2. The method of claim 1, wherein the predetermined near end echo response is derived by measuring echo response for a loop length of 18 kft, wherein the predetermined near end echo is an average of the echo response measured for a plurality of xDSL modems.

3. The method of claim 1, further comprising returning a flag indicating an invalid estimate if the loop is not a straight-loop configuration, wherein the loop is determined to be a non-straight loop configuration if no matching templates are found.

4. The method of claim 1, further comprising returning a flag indicating an invalid estimate if the loop length exceeds 9 kft in length.

5. The method of claim 1, wherein the set of templates comprises four templates, wherein the four templates correlate with Home Wiring Model 1, Home Wiring Model 2, an open termination on the loop, and a closed termination on the loop.

6. The method of claim 1, wherein the loop is comprised of 26 AWG (American Wire Gauge).

7. The method of claim 1, wherein the time-dependent scaling comprises multiplying the far end echo response by the expressions 10^{t/0.009}, wherein t represents time in milliseconds.

8. The method of claim 1, wherein subtracting the predetermined near end echo response from the received echo to derive a far end echo response further comprises curve fitting the difference to a 6^{th} order polynomial.

9. The method of claim 1, wherein identifying a matching template comprises:
determining whether a mean squared error associated with the far end response exceeds a predetermined threshold value; and
determining that the loop is not straight if the threshold value is exceeded.

10. An apparatus for performing single-end line testing (SELT), the apparatus comprising:
a transmitter adapted to transmit a test signal through a loop to be tested;
a receiver having an input that receives an echo response signal resulting from the transmission of the test signal;
a processing unit configured to subtract a predetermined near end echo response from the received echo response signal in order to derive a far end echo response;
a time scaler configured to perform time-dependent scaling on the far end echo response to compensate for loop attenuation; and
a comparison module configured to compare the time-scaled far end echo response to a set of predefined templates and provide an estimate of loop characteristics by identifying a matching template within the set of predefined templates, wherein the matching template contains information relating to loop characteristics comprising loop length and loop termination.

11. The apparatus of claim 10, wherein the predetermined near end echo response is derived by measuring echo response for a loop length of 18 kft, wherein the predetermined near end echo is an average of the echo response measured for a plurality of xDSL modems.

12. The apparatus of claim 10, further comprising an error indicator configured to return a flag indicating an invalid estimate if the loop is not a straight-loop configuration, wherein the loop is determined to be a non-straight loop configuration if no matching templates are found.

13. The apparatus of claim 12, wherein the error indicator is further configured to return a flag indicating an invalid estimate if the loop length exceeds 9 kft in length.

14. The apparatus of claim 10, wherein the set of templates comprises four templates, wherein the four templates correlate with Home Wiring Model 1, Home Wiring Model 2, an open termination on the loop, and a closed termination on the loop.

15. The apparatus of claim 10, wherein the loop is comprised of 26 AWG (American Wire Gauge).

16. The apparatus of claim 10, wherein the time-dependent scaling comprises multiplying the far end echo response by the expressions 10^{t/0.009}, wherein t represents time in milliseconds.

17. The apparatus of claim 10, wherein subtracting the predetermined near end echo response from the received echo to derive a far end echo response further comprises curve fitting the difference to a 6^{th} order polynomial.

18. The apparatus of claim 10, wherein the comparison module identifies a matching template by first determining whether a mean square error associated with the far end response exceeds a predetermined threshold value and determining that the loop is not straight if the threshold value is exceeded.

19. A program stored on a computer readable medium for performing single-end line testing (SELT) to determine loop characteristics for a loop, the program comprising:
logic for generating a test signal through a loop to be tested, wherein the test signal is a pseudo-random sequence;
logic for receiving an echo response;
logic for subtracting predetermined near end echo response from the received echo to derive a far end echo response;
logic for performing time-dependent scaling on the far end echo response to compensate for loop attenuation;
logic for comparing the time-scaled far end echo response to a set of predefined templates; and
logic for providing an estimate of loop characteristics by identifying a matching template within the set of predefined templates, wherein the matching template contains information relating to loop length and loop termination.

20. The program of claim 19, wherein the program is embodied in at least one of the following: customer premise equipment (CPE) and a central office (CO).
